(19) United States
(12) Patent Application Publication
(10) Pub. No.: US 2012/0055316 A1
(43) Pub. Date: Mar. 8, 2012

(54) Fishing Lure and Method of Manufacturing a Fishing Lure

(75) Inventors: Timothy G. Smith, St. Marys, PA (US); Ivan R. Smith, St. Marys, PA (US)

(73) Assignee: CONTINUOUS METAL TECHNOLOGY INC., Ridgway, PA (US)

(21) Appl. No.: 13/293,695

(22) Filed: Nov. 10, 2011

Related U.S. Application Data
(63) Continuation-in-part of application No. 12/051,293, filed on Mar. 19, 2008, now abandoned.
(60) Provisional application No. 60/918,831, filed on Mar. 19, 2007.
(60) Provisional application No. 60/931,363, filed on May 23, 2007.

(51) Int. Cl. G10D 13/08; B22F 3/12; B22F 3/26; A01K 85/00; A01K 85/01

(52) U.S. Cl. 84/404; 43/42.39; 43/42.32; 43/42.06; 419/27

(57) ABSTRACT

A scented article manufactured from a sintered metal powder. The metal powder may be one or more metals, one or more alloys, or any combination or mixture thereof. The scented article is of a weight sufficient to sink to a depth in the water and shaped such that, when urged through the water, the lure moves in a substantially oscillating motion. The scented article is impregnated with a scent, such as a fish attractant, that is slowly diffused in the water as the scented article is urged through the water. A method of manufacturing a scented article is also disclosed.

### CROSS REFERENCE TO RELATED APPLICATIONS

This application is a continuation-in-part of U.S. patent application Ser. No. 12/051,293, filed Mar. 19, 2008, which claims the benefit of priority of U.S. Provisional Patent Application Nos. 60/918,831, filed Mar. 19, 2007 and 60/931,363, filed May 23, 2007, all of which are incorporated herein by reference in their entirety.

### BACKGROUND OF THE INVENTION

1. Field of the Invention

The present invention relates general to a scented article and, in particular, to a scented lure for use in fishing, as well as a method of manufacturing the scented fishing lure.

2. Description of the Related Art

A wide variety of conventionally known scented articles have been developed to diffuse a scent to the surrounding environment. In some embodiments of the prior art, an ordinary article, such as a fishing lure, a wind chime, or a piece of jewelry, is coated with a scent by spraying or dipping the article in the scent. Such a coated article releases the scent to the environment to bait fish in the case of a scented fishing lure or create a pleasant smelling environment in the case of a wind chime or a piece of jewelry. In the case of a fishing lure and a wind chime, it is also desirable to have a hydro- or aero-dynamic shape to cause a desired movement of the fishing lure and the wind chime in the water and air, respectively.

Various fishing lures have been developed to aid fishermen in catching fish. Specifically, in order to catch a fish, the appropriate bait, line, hooks, etc. should be used, and if the angler decides against using live bait, the most appropriate lure should be used. There is a variety of differing shapes, styles and functioning of fishing lures, which are all designed to attract specific types of fish to bite or “hit” the lure (i.e., the hook). Therefore, it is of paramount importance that the lure be as lifelike as possible when trolled or urged through the water. In addition, it is important that the lure be trolled through the water at the appropriate depth in order to attract the target fish.

According to the prior art, lures that appear to have fishlike movements in the water are manufactured from or carved from wood or some similar synthetic material, e.g., plastics, polymers, etc. While such lures mimic the realistic movements of a small fish, they require the addition of extra weight on the fishing line or lure in order to obtain the action and depth to reach the targeted fish. Further, and according to the prior art, lures also are manufactured to appear like a fish and cause similar reflections of light as a live fish traveling through the water. For example, spoons and other metal lures are mass manufactured and rely upon the flashing, coloring or extra skirting to entice the fish to engage the lure.

Another example of an artificial fish-baiting lure arrangement is the odoriferous fishing device of U.S. Pat. No. 3,953,934 to Visser. This device works in conjunction with a lure, in this case a worm, which has multiple hooks extending from a surface thereof. The device is a sintered, metal body and must be used together with a lure portion. In particular, the device of the Visser patent includes interconnected pores filled with a fish attractant, which is released into the water from the pores in a uniform, slow rate to attract fish to the hooks on the lure. However, this device is not a lure, and instead must be used together with some other luring member, e.g., an artificial worm, fish, minnow, etc. Further, the device of the Visser patent is aerodynamically designed to eliminate movement in the water, and instead to move in front of the lure and release a scent in the water. U.S. Design Pat. No. D310,705 to Skripko illustrates a fishing lure having a planar longitudinal face opposite a curved longitudinal face, resulting in an asymmetric cross section across the longitudinal centerline. This design does not produce the desired oscillating, “fish-like” movement in water.

In embodiments there the fishing lure is scented with a fish attractant, such fish attractants generally have a base of fish oil with differing pungent scent enhancers added. These attractants may differ depending upon the target fish. One major drawback in the use of an attractant on today's fully-dense spoons and plastic lures is that the attractant washes off in the water, as it is being used. Additionally, conventional plastic scented baits are easily swallowed, rather than spit out, by the fish. In cases where the plastic scented bait is discarded or disconnected from the fishing line and then eaten by the fish, it cannot be digested by the fish and can cause a blockage which ultimately causes the fish to die.

In the case of a wind chime, one or more elements are vertically suspended from a stationary structure, such as a porch ceiling or a tree branch. Some wind chimes include a plurality of elements, such as hollow pipes of various lengths, in a circumferential arrangement about a central point. The plurality of elements are designed such that they have a high aerodynamic drag, which causes a relative movement of the elements in the wind. As the plurality of elements move in the wind, they often strike each other and/or the central point, causing the elements to emit a pleasant, melodic sound. As the wind increases or decreases in speed, the plurality of elements strike each other and/or the central point in randomized pattern to produce the sound. In an embodiment where the plurality of elements are scented by spraying or dipping them in a scented liquid, the wind chime releases a pleasant smell to the environment. However, a major disadvantage of such a design is that the scent diffuses or evaporates from the surface of the wind chime quickly, such that it no longer releases a pleasant smell to the environment. Wind chimes are often made from a wooden or smooth metallic material which cannot retain the scent for a long time. In order to impart the scent to the wind chime, the user must purchase a new, scented wind chime, or apply a new coat of the scented liquid to the wind chime. This process can be quite expensive and laborious, often causing the users to abandon the idea of having a scented wind chime altogether.

In the case of jewelry items, such as earrings, necklaces, watches, rings, pendants, or the like, it is desirable to impart a pleasant smell to such articles for the purpose of releasing a pleasant smell to environment when worn by the user. This is further advantageous when the user cannot wear perfume on clothing or directly on the skin due to allergies. However, as in the case of scented wind chimes, merely coating the jewelry item with a scent is not effective because the scent evaporates too quickly and requires constant re-coating to have the desired effect.

As seen above, there is considerable room for improvement in the area of design and manufacture of scented articles. In particular, there is a need for a fishing lure that moves in a lifelike manner in the water, and is capable of effectively submersing to the appropriate level without additional components. There is also a need for a fishing lure that attracts the fish in use, whether by movement or reflective light (and vision). Further improvement is possible in the art of design and manufacture of wind chimes, where the wind chime is operative for releasing a scent to the environment. Additionally, there is a need in the art for a scented jewelry article that maintains the scent for a long period of time.

### SUMMARY OF THE INVENTION

It is, therefore, one object of the present invention to provide a scented article that overcomes the drawbacks and deficiencies of the prior art. It is another object of the present invention to provide scented article in the form of a a fishing lure that moves in a lifelike manner when under water. It is a further object of the present invention to provide scented article in the form of a fishing lure that is an appropriate weight to descend under water to the location of the target fish. It is a still further object of the present invention to provide a scented article in the form of a fishing lure that reflects light in a manner similar to a live fish. It is yet another object of the present invention to provide a scented article in the form of a fishing lure that does not require additional components to operate and function in the desired lifelike manner.

The scented article having the form of a fishing lure may be manufactured from a sintered metal powder comprising at least one of the following: at least one metal, at least one alloy or any combination or mixture thereof. The scented article in the form of a fishing lure may have a weight sufficient to sink to a depth in water. The fishing lure desirably includes a body having a first side surface, a second side surface opposite the first side surface along a longitudinal centerline of the body, and an edge surface extending along the longitudinal length of the body and separating the first side surface and the second side surface. The body may have a widened central portion extending across the longitudinal centerline of the lure adapted for causing the fishing lure to move in substantially oscillating motion when urged through water. At least one of the first side surface, the second side surface and the edge surface may include at least one undulation sufficient to cause the fishing lure to move in the substantially oscillating motion. Additionally, at least one orifice or bore may extend through the body and sized and shaped for the attachment of at least one of the following: at least one discontinuous loop of metal, a fishing line, at least one fishing hook, a fishing component or any combination thereof.

The scented article in the form of a fishing lure may further include a first orifice extending through a first end of the fishing lure, a second orifice extending through a second end of the fishing lure, and a discontinuous loop of metal attached through at least one of the first orifice and the second orifice. The fishing lure may include at least one design on at least a portion of at least one surface of the body, wherein the design is formed to represent at least one of the following: scales, eyes, mouth, a fish body part or any combination thereof. Furthermore, the fishing lure may include at least one slot extending at least partially within at least a portion of at least one surface of the body, wherein the slot is sized and shaped so as to at least partially engage a prefabricated, artificial fin therein. The fishing lure may be at least partially impregnated or injected with, or soaked in, a fish attracting material.

In another embodiment of the present invention, a method of manufacturing a scented article, includes the steps of filling a mold with metal powder, applying pressure to the metal powder in the mold, thereby providing a compacted form, sintering the compacted form under specified processing parameters, thereby forming an unscented form of the scented article, and impregnating the unscented form of the scented article with a scented fluid. The scented article may have a body that includes a first side surface, a second side surface opposite the first side surface along a longitudinal centerline of the body, and an edge surface extending across the longitudinal centerline of the body and separating the first side surface and the second side surface. The body may have a widened central portion extending across the longitudinal centerline of the body adapted for causing the scented article to move in substantially oscillating motion when urged through water or when moved by wind.

The metal powder used for manufacturing the scented article may include at least one of the following: at least one metal, at least one alloy, at least one lubricant, at least one binding agent, at least one wax-based material, at least one polymer-based material or any combination or mixture thereof. The metal powder may include at least one metal, and the metal may be at least one of the following: iron, copper, nickel, chromium, tin, zinc, molybdenum, magnesium, tungsten, aluminum. After compacting and prior to sintering, the method further may include the step of at least partially de-binding the compacted metal powder. The pressure applied to the metal powder may be from about 10 tons per square inch to about 60 tons per square inch. The sintering step may occur at a temperature between about 1,000° F. to about 2,800° F. and for a time period between about 20 minutes and about 180 minutes. The sintering may occur in a furnace having atmospheric conditions including at least one of the following: an inert atmosphere, a reducing atmosphere, a vacuum, nitrogen and hydrogen. After sintering, the formed scented article desirably has a density of about 50% to about 99% of the theoretical density of the metal powder.

The mold for making the scented article may be sized and shaped so as to form at least one surface of the scented article with at least one undulation sufficient to cause the scented article to move in substantially oscillating motion. At least a portion of the unscented form of the scented article may be impregnated with a scented fluid by placing the unscented form of the scented article in a container with the scented fluid and drawing a vacuum to impregnate the scented fluid in the pores of the unscented form of the scented article.

According to another embodiment of the present invention, a scented wind chime may be manufactured from a sintered metal powder comprising at least one of the following: iron, copper, nickel, chromium, tin, zinc, molybdenum, magnesium, tungsten, aluminum, brass, bronze, stainless steel, carbon steel or any combination, alloy or mixture thereof. The scented wind chime may include a plurality of wind chime elements, each wind chime element having a body having a first side surface, a second side surface opposite the first side surface along a longitudinal length of the body, and an edge surface extending along the longitudinal centerline of the body and separating the first side surface and the second side surface. At least one of the first side surface, the second side surface and the edge surface may include at least one undulation that creates a central widened portion extending across the longitudinal centerline of the body, the at least one undulation adapted to cause the wind chime element to move in a substantially oscillating motion in the wind. Each wind chime element may be impregnated with a scented fluid.

### BRIEF DESCRIPTION OF THE DRAWINGS

FIG. 1 is a side view of one embodiment of a scented article in the form of a fishing lure manufactured in accordance with the principles of the present invention;

FIG. 2 is an edge view of the fishing lure of FIG. 1;

FIG. 3 is a perspective view of the fishing lure of FIG. 1;

FIG. 4 is a side view of another embodiment of a scented article in the form of a fishing lure manufactured in accordance with the principles of the present invention;

FIG. 5 is a side view of a further embodiment of a scented article in the form of a fishing lure manufactured in accordance with the principles of the present invention;

FIG. 6 is a side view of a still further embodiment of a scented article in the form of a fishing lure manufactured in accordance with the principles of the present invention;

FIG. 7 is a perspective view of another embodiment of scented article in the form of a fishing lure manufactured in accordance with the principles of the present invention;

FIG. 8 is a perspective view of another embodiment of scented article in the form of a wind chime manufactured in accordance with the principles of the present invention; and

FIG. 9 is a perspective view of another embodiment of scented article in the form of a jewelry item manufactured in accordance with the principles of the present invention

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The present invention is directed to a scented article 10, as illustrated in various views and embodiments in FIGS. 1-9. In addition, the present invention is directed to a method of manufacturing scented article 10. As discussed above with regard to an article in the form of a fishing lure, one of the drawbacks of the prior art is the inability of the lure to move in a lifelike, i.e., “fish-like” manner, appear like live fish to the target fish, descend to the appropriate level or depth in the water, and/or release a scent in the water to attract the fish. As discussed hereinafter, one or more of the preferred and non-limiting embodiments of the present invention overcome some or all of these drawbacks.

The method of manufacturing the scented article 10 will be described with particular emphasis on the manufacture of a fishing lure, as illustrated in FIGS. 1-7. However, it will become apparent to one of ordinary skill in the art that the steps for the method of manufacturing a scented fishing lure are equally applicable to the manufacture of other scented articles, such as a wind chime, as shown in FIG. 8, or a jewelry item, as shown in FIG. 9. In order to manufacture the scented article 10 of the present invention, the first step is to provide or obtain a metal powder, which may be in the form of a metal powder mixture. While this metal powder or metal powder mixture may include a single type of metal, in one preferred and non-limiting embodiment, it is a mixture of various types of metals or alloys of these metals. For example, these metals may be iron, copper, nickel, chromium, tin, zinc, molybdenum, magnesium, tungsten, aluminum or any combination, mixtures or alloys thereof, and the alloys may be brass, bronze, stainless steel, carbon steel, etc. In particular, all of the above-mentioned metals and alloys can be obtained in a powdered form.

Once the powdered metal material is obtained, this material or mixture is placed in an appropriately sized and shaped mold. Such molds are well known in the art. Further, the mold would include an appropriate inner cavity to form the scented article 10 in a desired shape that leads to the oscillating fish-like motion, such as the shape illustrated in FIGS. 1-7, or causes movement of the scented article in the wind, such as the shape illustrated in FIG. 8. Once the mixture is placed in the mold, pressure is applied to the metal powder in order to compact this mixture. In one preferred and non-limiting embodiment, the applied pressure is in the range of about 5 to about 60 tons per square inch. Such pressure results in a “green” or un-sintered, compacted form of the scented article 10. The green compact desirably has a theoretical density between 50-80% of the starting material.

It should be noted that the un-sintered compacted form of the scented article 10 can be produced through an injection molding method, wherein the metal powder is injected into the mold cavity and is compacted through the injection process, or through a mechanical die compaction method, wherein the metal powder is compacted by applying pressure to die components surrounding the metal powder. In either method, a compacted form of the scented article 10 is produced. In addition, and dependent upon the molding method utilized, certain additives may be used to facilitate the molding process. For example, the metal powder may be a metal powder mixture that contains a lubricant or binding agent to facilitate the injection molding or mechanical compaction processes. The lubricant may be a wax- or polymer-based material.

Next, in one preferred and non-limiting embodiment, the compacted form is debound in a de-binding process. This processing step can be used to remove the lubricant or binding agent prior to sintering, or alternatively, these materials can be removed at a point during the sintering process (as discussed hereinafter). Next, this compacted form is sintered and results in the sintered scented article 10 of the present invention. Further, the de-binding and sintering processes may be accomplished in a known continuous processing system.

In one preferred and non-limiting embodiment, the sintering occurs at a temperature between about 1,000° F. to about 2,800° F. and for a time period between about 20 minutes and about 180 minutes. Further, sintering may occur in a furnace configured to exhibit certain atmospheric conditions, e.g., an inert atmosphere, a reducing atmosphere, a vacuum, nitrogen, hydrogen, etc. Still further, after sintering, the formed fishing lure 10 may have a density of about 50% to about 99% the theoretical density of the starting material, i.e., the metal powder.

In one example of the method of manufacturing the scented article 10 of the present invention, the mold is filled in a dual-action press, and the powdered mixture is a standard 316 stainless steel powder, which includes 15-18% by weight chromium, 10-14% by weight nickel, 2-3% by weight molybdenum, 0.5-1.25% by weight lithium stearate (as a lubricant) and the balance iron. The mold desirably includes an upper punch, a lower punch, and a die having a curved shape corresponding to the outer shape of the scented article 10, shown as a fishing lure in FIGS. 1-7. Two pins are further provided for forming two rounded, hollow portions of the fishing lure. Upper and lower punches are compacted to 25-40 tons per square inch. The resulting “green” form has a density of 5.4 g/cm3, or 68% of the theoretical density. The green is then is placed in a continuous sintering furnace, such as a two-zone CI Hayes 8-inch pusher furnace. The furnace includes a first (de-binding) zone set at about 1,400° F. for 0.5-1 hour, where the atmosphere inside the furnace is 90% nitrogen and 10% hydrogen. Next, the temperature in the second (sintering) zone is set at 2200-2,350° F., also for 0.5-3 hours, where the atmosphere inside the furnace is 25% nitrogen and 75% hydrogen. The resulting article has a density of 5.8 g/cm³, or 73% of the theoretical density.

While discussed in connection with a compacted or “green” form, it is also envisioned that this “green” or intermediate (compacted) form is manufactured in a variety of manners. For example, this intermediate form may be created in an injection molding process, and subsequently sintered (as discussed above). Other processes to create and provide this pre-sintered form may be used within the context of the present invention.

In one non-limiting embodiment, the scented article 10 may be manufactured to obtain a specified porosity. Accordingly, and through the manufacturing process, the porosity is capable of being controlled. The powdered metal process is one in which the density/porosity of the finished part can be utilized in providing additional fish attractant mechanisms and functions. In general, the density/porosity is controlled by means of powder type, powder size and shape selection, compaction pressure, and/or sintering conditions, etc.

The scented article 10 can be injected or impregnated with a scented liquid, such as a fish attractant in an embodiment where the scented article 10 is a fishing lure, a pleasant smelling fluid in an embodiment where the scented article 10 is a wind chime, or perfume in an embodiment where the scented article 10 is a jewelry item. This scented fluid used to impart a scent to the scented article can be placed into the body of the scented article 10 by a number of methods, including (but not limited to): vacuum impregnation (covering the scented article 10 in the scented fluid, and then drawing a vacuum); heating the scented article 10, and then soaking it in the scented fluid; directly injecting or forcing the scented fluid into the body of the scented article 10; and/or some prolonged soaking period, where the scented fluid penetrates the pores of the body of the scented article 10. In one, non-limiting example, the unscented form of the scented article 10 is placed in a glass container containing a scented fluid, such as a fish attractant. The container is placed in a vacuum chamber set at 28″ of mercury for 20 minutes. The vacuum is then released and excess scented fluid, such as a fish attractant, is drained from the now scent-impregnated scented article 10 through a strainer. The scent-impregnated scented article 10 is then ready for use or additional processing steps to form a completed fishing lure, wind chime, or a jewelry item. As the scented fluid fills the pores of the scented article 10, the scent remains on the scented article 10 through multiple uses, whether in the form of a fishing lure, a wind chime, or a jewelry item.

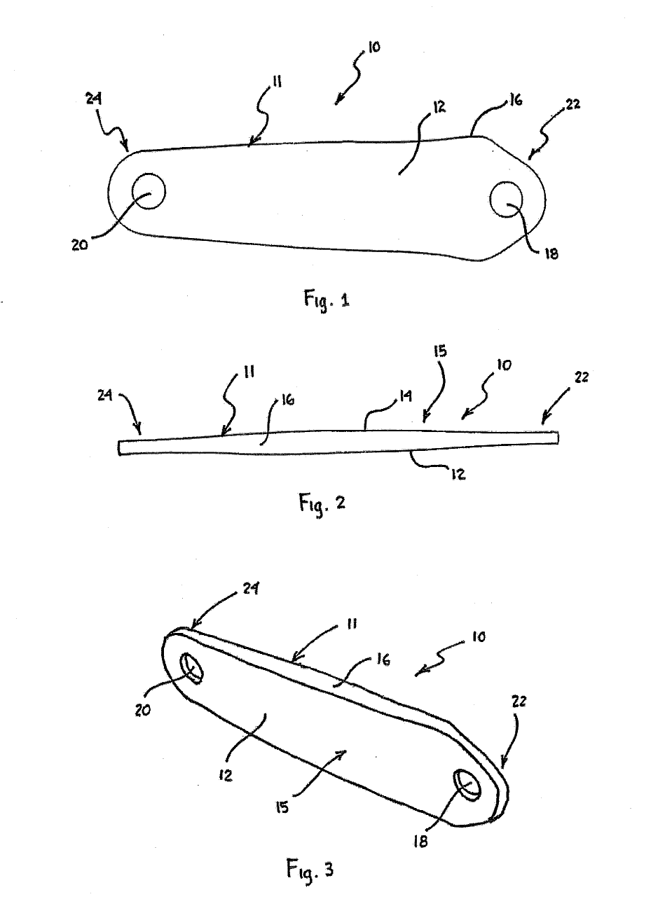

One non-limiting embodiment of the shape of the scented article 10 in the from of a fishing lure is illustrated in FIGS. 1-6. With specific reference to FIGS. 1-6, the scented article 10 includes a body 11 having a first side surface 12, a second side surface 14 opposite the first side surface along the longitudinal length of the body 11, and an edge surface 16 running along the longitudinal length of the body 11. The edge surface 16 separates the first side surface 12 from the second side surface 14. In addition, and as best illustrated in FIG. 2, each of the first side surface 12 and the second side surface 14 includes specific undulations 15 and/or relative depths and curvature, which mimic the shape of a fish. The undulations 15 are desirably formed symmetrically along the longitudinal length of the scented article 10. In the embodiment illustrated in FIG. 2, two undulations 15 are formed at a front and rear portion of each of the first side surface 12 and the second side surface such that the lure has a widened central portion extending symmetrically along the longitudinal length of the scented article 10. In addition, and based upon the shape of the side surfaces 12, 14 (or the edge surface 16), when the scented article 10 is submerged and subsequently urged or pulled through the water, undulations 15 are adapted to cause the scented article 10 in the form of a lure to move in an oscillating or back-and-forth (fish-like) motion. Accordingly, the mold used to form the scented article 10 shown in FIGS. 1-6 includes an inner cavity that imparts these undulations and differentiating thicknesses upon the surfaces 12, 14 of the scented article 10. In addition, and as best seen in FIG. 1, the edge surface 16 is also formed in a generally fish-like shape, which is also accomplished through the shape of the inner cavity of the mold, and may also serve to impart certain motion characteristics upon the scented article 10 during operation and use. One of ordinary skill in the art will realize that undulations 15 formed on side surfaces 12 and 14 need not be symmetric about the longitudinal length of the scented article 10. For example, first side surface 12 may have one or more undulations 15 located in the front part while the second side surface 14 may have one or more undulations 15 located in the rear part.

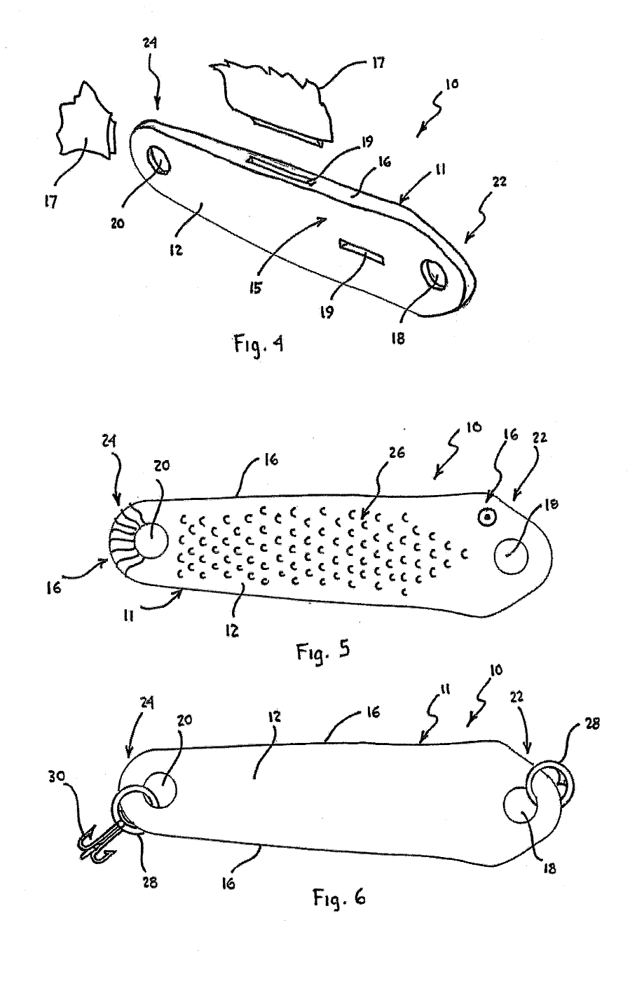

In another non-limiting embodiment of the scented article 10 in the form of a fishing lure, fins may be added to the body 11 during the molding process, as based upon the shape of the mold. However, and as illustrated in FIG. 4, prefabricated fins 17 can be attached or otherwise coupled to the body 11 after the sintering process is complete, or even by the consumer prior to use. As seen in the exemplary embodiment of FIG. 4, these fins 17 can be pressed into engagement within one or more slots 19 formed on the surfaces 12, 14, 16 of the body 11. These fins 17 can be decorative, in order to allow the scented article 10 in the form of a fishing lure to appear more fish-like to the target fish, and, dependent upon shape and design, may further assist in imparting the oscillating motion that primarily occurs as a result of the shape of the body 11 itself. A variety of types, colors, shapes and sizes of fins 17 can be used in an interchangeable manner with the slots 19 on the body 11 dependent upon the user's experience or understanding of the target fish.

As illustrated in FIG. 5, and in another preferred and non-limiting embodiment, in order to provide for the attachment of other elements to the scented article 10, a first orifice 18 extends through a first end 22 of the body 11 of the scented article 10, and a second orifice 20 extends through a second end 24 of the body 11 of the scented article 10. In operation, the first orifice 18 is at the “eye” end of the body 11 of the scented article 10, while the second orifice 20 is positioned at the “tail” end of the body 11 of the lure 10. These orifices 18, 20 may be formed during the molding process, or alternatively punched through the form (or scented article 10) during or after the compacting, de-binding and/or sintering processes.

In another preferred and non-limiting embodiment, and as also illustrated in FIG. 5, the surfaces 12, 14, 16 may also include additional design aspects and features. In particular, fish-like design elements 26 may be appropriately positioned or created on the first side surface 12 and/or the second side surface 14. Further, these design elements 26 may be representative or in the appearance of scales, fins, eyes, mouth, etc. Accordingly, by using these design elements 26, not only does the scented article 10 in the form of a fishing lure look more lifelike to the target fish, it also will reflect light in a more lifelike manner. Such reflection also occurs due to the “metallic” nature of the scented article 10.

The design elements 26 may be disposed or created on the first side surface 12 and/or the second side surface 14 in a variety of manners. For example, the design elements 26 may be created during the manufacturing process discussed above, such as through the use of the mold and elements of the mold that provide the undulations 15, curved features, relative thicknesses on the scented article 10. However, as with the orifices 18, 20 and, in some embodiments, the slots 19, the design elements 26 may also be applied to the side surfaces 12, 14 after the compacting, de-binding and sintering processes. Specifically, these design elements 26 may be etched or otherwise applied to the surfaces 12, 14 in a later stage of manufacturing, or even by the user of the scented article 10 in the form of a fishing lure after purchase.

In a further preferred and non-limiting embodiment, and as illustrated in FIG. 6, various appurtenances and components can be attached directly to the scented article 10 in the form of a fishing lure, e.g., via the orifices 18, 20, or indirectly to the scented article 10, e.g., via other attaching arrangements. For example, as shown in FIG. 6, a discontinuous loop (normally made of metal) 28 (e.g., a key-ring arrangement) may be attached to the first orifice 18 and/or the second orifice 20. In this manner, the angler may attach the fishing line (not shown) to the loop 28 attached through the first orifice 18 (or the “eye” end of the body 11 of the scented article 10), while a loop 28 may also be attached to the second orifice 20 of the scented article 10 (or the “tail” end of the body 11 of the scented article 10). Further, a hook 30 may be attached to the loop 28 positioned at the second orifice 20 of the scented article 10. Of course, any fishing components or items may be attached to scented article 10 by the user and by using these loops 28.

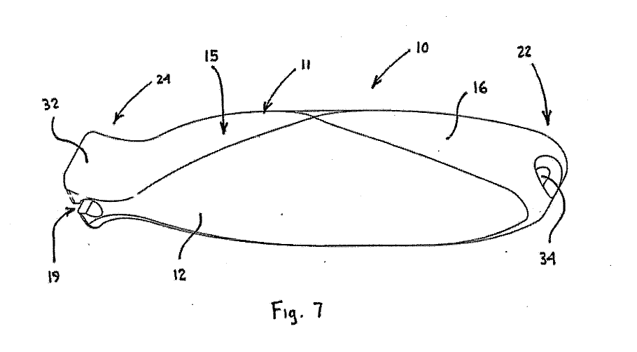

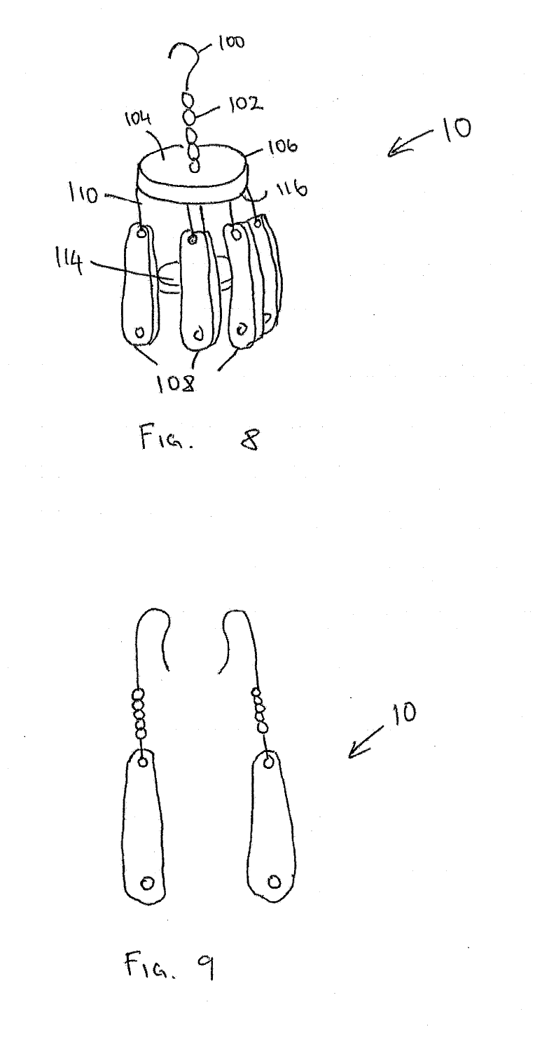

A still further preferred and non-limiting embodiment of the scented article 10 of the present invention is illustrated in FIG. 7. As discussed above in connection with the previous embodiments, the scented article 10 of this embodiment is formed into a shape that provides the oscillating motion when pushed, pulled or urged through the water. As demonstrated in FIG. 7, the scented article 10 is formed in a more “fish-like” shape with the appropriate undulations 15 and/or curvature on the side surfaces 12, 14 and the edge surface 16, which lead to this oscillating movement. Further, a tail portion 32 is formed near the second end 24 of the body 11. Based upon the shape of this tail portion 32 and the overall “fish-like” shape of the body 11, the scented article 10 of this embodiment provides a more realistic and “baiting” or attractive shape to the target fish.

In addition, in this embodiment, a central bore 34 extends from the first end 22 (or “head” end) of the scented article 10 through the body 11 and to the second end 24 (or “tail” end) of the scented article 10. In operation, the fishing line (not shown) can be fed through this bore 34 at the first end 22 and either attached to a hook 30 at the second end 24, or alternatively, attached to the second end 24 or tail portion 32 of the scented article 10. Still further, in this embodiment, a slot 19 is formed at the second end 24 at the tail portion 32, such that the fishing line can be attached around side surfaces 12, 14 and/or edge surface 16 of the scented article 10 in the area surrounding the slot 19. Of course, and as discussed above, the slot 19 may be used to attach other components to the scented article 10. In one method of manufacturing the shape of the body 11 of the scented article 10 of this embodiment, the above-discussed injection molding process is used to obtain the “green” or compacted form of the scented article 10 prior to sintering.

In this manner, and due to the shape of the scented article 10 of the present invention, the scented article 10 in the form of a fishing lure moves in an oscillating or back-and-forth motion through the water in a lifelike manner. Still further, due to the manufacturing method discussed above, and by using the sintered metal powder material, the resultant scented article 10 exhibits the appropriate weight characteristics to descend into the water to the target fish location, without the requirement of additional weights attached thereto. Since the scented article 10 does not require additional weights attached thereto, it assumes the shape of a real fish, which increases the chances that the target fish will “hit” the scented article 10. Still further, and in some embodiments, by applying the appropriate design elements 26, together with the metallic finish of the scented article 10, the scented article 10 exhibits the appropriate reflective characteristics, which also provide a more lifelike appearance to the target fish. Still further, the scented article 10 of the present invention is in a form that permits the user to add other features to the scented article 10, e.g., fins 17, design elements 26, etc., which permits the user to be in control of how to tailor and create the most useful and successful scented article 10. In this manner, and by using the inventive process, a scented article 10 is provided that appears and acts in a lifelike manner, and descends to the appropriate depth to the target fish location. Additionally, the scented article 10 made in the form of a fishing lure is able to retain the scent of the fish attractant through multiple uses.

With reference to FIG. 8, another embodiment of the scented article 10 in the form of a wind chime is illustrated, the scented article 10 includes a hanger 100 for suspending the scented article 10 from a stationary structure, such as a tree branch. The hanger 100 may be in the form of a hook, a screw, a nail, or similar structure capable of supporting the wind chime on a stationary structure. A chain 102 extends vertically downward from the hanger 100. One end of the chain 102 is connected to the hanger 100 while the opposing end of the chain 102 is coupled to a top portion 104 of a connection element 106. The connection element 106 couples the chain 102 to a plurality of wind chime elements 108 via strings 110.

Each wind chime element 108 is connected to an outer periphery of the connection element 106 via the string 110. The plurality of wind chime elements 108 are circumferentially arranged about the outer periphery of the connection element 106. Each wind chime element 108 may be coupled to the connection element 106 by passing the string 110 through a corresponding hole provided on the connection element 106. A sounding element 114 extends vertically downward from the center of the bottom portion 116 of the connection element 106 via a string 108. The sounding element 114 is placed vertically with respect to the wind chime elements 108 such that at least a portion of each wind chime element 108 is capable of striking the sounding element 114 as the wind chime elements 108 move in the wind. In an alternate embodiment, the sound element 114 may be omitted. In this case, the sound is produced as the wind chime elements 108 strike each other during movement caused by the wind.

Like the scented article 10 in the from of a fishing lure, the scented article 10 in the form of a wind chime may be manufactured from a sintered metal powder comprising at least one of the following: iron, copper, nickel, chromium, tin, zinc, molybdenum, magnesium, tungsten, aluminum, brass, bronze, stainless steel, carbon steel or any combination, alloy or mixture thereof. Furthermore, each wind chime element 108 desirably has a body having a first side surface, a second side surface opposite the first side surface along a longitudinal length of the body, and an edge surface extending along the longitudinal centerline of the body and separating the first side surface and the second side surface. At least one of the first side surface, the second side surface and the edge surface include at least one undulation that creates a central widened portion extending across the longitudinal centerline of the body, the at least one undulation adapted to cause the wind chime element to move in a substantially oscillating motion in the wind. This shape of the wind chime element 108 has the basic shape of the fishing lure shown in FIGS. 1-6.

In some embodiments, the connection element 106, wind chime elements 108, and the sounding element 114 of the scented article 10 shown in FIG. 8 are made of like materials that have been scent impregnated in accordance with the teachings of the present invention. Alternatively, only the wind chime elements 108 are impregnated with a scent from a scented liquid. The wind chime elements 108 of the scented article 10 shown in FIG. 8 may have the same structure as the scented article 10 in the form of a fishing lure shown in FIGS. 1-7.

With reference to FIG. 9, another embodiment of the scented article 10 in accordance with the teachings of the present invention is illustrated. The scented article 19 has the form of a jewelry item. FIG. 9 illustrates the scented article 10 in the form of a pair of earrings; however, the teachings of the present invention are equally applicable to other forms of jewelry items, such as necklaces, bracelets, rings, watches, pendants, or the like. The scented shown in FIG. 9 is infused with a scent from a scented fluid, such as perfume, in a manner described above. The infusion of the scent into the scented article 10 allows for slow and controlled diffusion of the scent, which can last for months. One benefit of the scented article 10 made in the from of a jewelry item is that individuals who are overly sensitive to the smell of perfume or allergic to the same can wear the scented article 10 without directly applying the scent to their body or clothing. Therefore, these individuals can benefit from being surrounded in an environment of a pleasant smell without enduring the side effects related to their sensitivity and/or allergy to the scent being applied directly to the body or clothing.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. In another alternate embodiment, the scented article 10 may take the form of an item impregnated with a scent for pest control. For example, this item could be placed on a fence, such as a chain link fence, for the purpose of repelling pests.

What is claimed is:

1. A fishing lure manufactured from a sintered metal powder comprising at least one of the following: at least one metal, at least one alloy or any combination or mixture thereof, wherein the fishing lure has a weight sufficient to sink to a depth in water, and wherein the fishing lure comprises a body that includes a first side surface, a second side surface opposite the first side surface along a longitudinal centerline of the body, and an edge surface extending along the longitudinal length of the body and separating the first side surface and the second side surface, the body having a widened central portion extending across the longitudinal centerline of the lure adapted for causing the fishing lure to move in substantially oscillating motion when urged through water.

2. The fishing lure of claim 1, wherein at least one of the first side surface, the second side surface and the edge surface comprises at least one undulation sufficient to cause the fishing lure to move in the substantially oscillating motion.

3. The fishing lure of claim 2, further comprising at least one orifice or bore extending through the body and sized and shaped for the attachment of at least one of the following: at least one discontinuous loop of metal, a fishing line, at least one fishing hook, a fishing component or any combination thereof.

4. The fishing lure of claim 3, further comprising:
a first orifice extending through a first end of the fishing lure;
a second orifice extending through a second end of the fishing lure; and
a discontinuous loop of metal attached through at least one of the first orifice and the second orifice.

5. The fishing lure of claim 2, further comprising at least one design on at least a portion of at least one surface of the body, wherein the design is formed to represent at least one of the following: scales, eyes, mouth, a fish body part or any combination thereof.

6. The fishing lure of claim 2, further comprising at least one slot extending at least partially within at least a portion of at least one surface of the body, wherein the slot is sized and shaped so as to at least partially engage a prefabricated, artificial fin therein.

7. The fishing lure of claim 1, wherein the fishing lure is at least partially impregnated or injected with, or soaked in, a fish attracting material.

8. A method of manufacturing a scented article, comprising the steps of:
filling a mold with metal powder;
applying pressure to the metal powder in the mold, thereby providing a compacted form;
sintering the compacted form under specified processing parameters, thereby forming an unscented form of the scented article; and
impregnating the unscented form of the scented article with a scented fluid;
wherein the scented article comprises a body that includes a first side surface, a second side surface opposite the first side surface along a longitudinal centerline of the body, and an edge surface extending across the longitudinal centerline of the body and separating the first side surface and the second side surface, the body having a widened central portion extending across the longitudinal centerline of the body adapted for causing the scented article to move in substantially oscillating motion when urged through water or when moved by wind.

9. The method of claim 8, wherein the specified processing parameters include at least one of the following: sintering time, sintering temperature, sintering pressure, atmospheric conditions or any combination thereof.

10. The method of claim 8, wherein the metal powder comprises at least one of the following: at least one metal, at least one alloy, at least one lubricant, at least one binding agent, at least one wax-based material, at least one polymer-based material or any combination or mixture thereof.

11. The method of claim 10, wherein the metal powder comprises at least one metal, and the metal is at least one of the following: iron, copper, nickel, chromium, tin, zinc, molybdenum, magnesium, tungsten, aluminum.

12. The method of claim 8, wherein, after compacting and prior to sintering, the method further comprises at least partially de-binding the compacted metal powder.

13. The method of claim 8, wherein the pressure applied to the metal powder is from about 10 tons per square inch to about 60 tons per square inch.

14. The method of claim 8, wherein the metal powder comprises a stainless steel powder mixture including chromium, nickel and molybdenum.

15. The method of claim 8, wherein the sintering occurs at a temperature between about 1,000° F. to about 2,800° F. and for a time period between about 20 minutes and about 180 minutes.

16. The method of claim 8, wherein the sintering occurs in a furnace having atmospheric conditions including at least one of the following: an inert atmosphere, a reducing atmosphere, a vacuum, nitrogen and hydrogen.

17. The method of claim 8, wherein, after sintering, the formed scented article has a density of about 50% to about 99% of the theoretical density of the metal powder.

18. The method of claim 8, wherein the mold is sized and shaped so as to form at least one surface of the scented article with at least one undulation sufficient to cause the scented article to move in the substantially oscillating motion.

19. The method of claim 8, wherein at least a portion of the unscented form of the scented article is impregnated with a scented fluid by placing the unscented form of the scented article in a container with the scented fluid and drawing a vacuum to impregnate the scented fluid in the pores of the unscented form of the scented article.

20. A scented wind chime manufactured from a sintered metal powder comprising at least one of the following: iron, copper, nickel, chromium, tin, zinc, molybdenum, magnesium, tungsten, aluminum, brass, bronze, stainless steel, carbon steel or any combination, alloy or mixture thereof, the scented wind chime comprising a plurality of wind chime elements, each wind chime element having a body having a first side surface, a second side surface opposite the first side surface along a longitudinal length of the body, and an edge surface extending along the longitudinal centerline of the body and separating the first side surface and the second side surface, wherein at least one of the first side surface, the second side surface and the edge surface comprise at least one undulation that creates a central widened portion extending across the longitudinal centerline of the body, the at least one undulation adapted to cause the wind chime element to move in a substantially oscillating motion in the wind, and wherein each wind chime element is impregnated with a scented fluid.
